(19) United States
(12) Patent Application Publication
(10) Pub. No.: US 2010/0290899 A1
(43) Pub. Date: Nov. 18, 2010

(54) VEHICULAR TURBOCHARGER COMPONENTS

(75) Inventors: Andri E. Elia, Chadds Ford, PA (US); Michael R. Day, Bloomfield Hills, MI (US); Andrew Wang, Toronto (CA); Jonathan McCrea, Toronto (CA)

Correspondence Address: Rankin, Hill & Clark LLP, 23755 Lorain Road, Suite 200, North Olmsted, OH, 44070, US

(73) Assignees: MORPH TECHNOLOGIES, INC., Toronto, ON (CA); E.I. DU PONT DE NEMOURS AND COMPANY, Wilmington, DE (US)

(21) Appl. No.: 12/681,359

(22) PCT Filed: Oct. 1, 2008
(86) PCT No.: PCT/US08/11355

§ 371 Date: Aug. 3, 2010

Related U.S. Application Data
(60) Provisional application No. 60/997,586, filed on Oct. 4, 2007.

(51) Int. Cl. F04D 29/42; B32B 15/08; B32B 5/00

(52) U.S. Cl. 415/182.1; 428/457; 428/339

(57) ABSTRACT

Metal plated organic polymer compositions are useful as vehicular turbochargers components. Such components may have lighter weight, and/or superior corrosion resistance, and/or be more easily fabricated than conventional turbocharger components.

### FIELD OF THE INVENTION

Organic polymers which are metal plated are useful for vehicular turbocharger components.

### TECHNICAL BACKGROUND

Vehicles such as automobiles, trucks, motorcycles, scooters, recreational and all terrain vehicles, farm equipment such as tractors, and construction equipment such as bulldozers and graders are of course important items in modern society, and they are made of a myriad of parts. Also important are stationary internal combustion engines such as those used to power generators. Many of these parts must have certain minimum physical properties such as stiffness and/or strength. Traditionally these types of parts have been made from metals such as steel, aluminum, zinc, and other metals, but in recent decades organic polymers have been increasingly used for such parts for a variety of reasons. Such polymeric parts are often lighter, and/or easier (cheaper) to fabricate especially in complicated shapes, and/or have better corrosion resistance. However such polymeric parts have not replaced metals in some application because the they are not stiff and/or strong enough, or have other property deficiencies compared to metal.

Thus vehicle manufacturers have been searching for ways to incorporate more polymeric materials into their vehicles for a variety of reasons, for example to save weight, lower costs, or provide more design freedom. Thus improved polymeric turbocharger components have been sought by vehicle manufacturers. It has now been found that metal coated organic polymeric vehicular turbocharger components (VTCB) have the properties desired.

Metal plated polymeric parts have been used in vehicles, especially for ornamental purposes. Chrome or nickel plating of visible parts, including polymeric parts, has long been done. In this use the polymer is coated with a thin layer of metal to produce a pleasing visual effect. The amount of metal used is generally the minimum required to produce the desired visual effect and be durable.

U.S. Pat. No. 4,406,558 describes a gudgeon pin for an internal combustion engine which is metal plated polymer. U.S. Pat. No. 6,595,341 describes an aluminum plated plastic part for a clutch. Neither of these patents mentions VTCs.

### SUMMARY OF THE INVENTION

This invention concerns a vehicular turbocharger component, comprising an organic polymer composition which is coated at least in part by a metal.

This invention concerns a vehicle comprising one or more turbocharger components, which comprise an organic polymer composition which is coated at least in part by a metal.

### DETAILS OF THE INVENTION

Herein certain terms are used and some of them are defined below:

By an “organic polymer composition” is meant a composition which comprises one or more organic polymers. Preferably one or more of the organic polymers is the continuous phase.

By an “organic polymer” (OP) is meant a polymeric material which has carbon-carbon bonds in the polymeric chains and/or has groups in the polymeric chains which have carbon bound to hydrogen and/or halogen. Preferably the organic polymer is synthetic, i.e., made by man. The organic polymer may be for example a thermoplastic polymer (TPP), or a thermoset polymer (TSP).

By a “TPP” is meant a polymer which is not crosslinked and which has a melting point and/or glass transition point above 30° C., preferably above about 100° C., and more preferably above about 150° C. The highest melting point and/or glass transition temperature is also below the point where significant thermal degradation of the TPP occurs. Melting points and glass transition points are measured using ASTM Method ASTM D3418-82. The glass transition temperature is taken at the transition midpoint, while the melting point is measured on the second heat and taken as the peak of the melting endotherm.

By a “TSP” is meant a polymeric material which is crosslinked, i.e., is insoluble in solvents and does not melt. It also refers to this type of polymeric material before it is crosslinked, but in the final VTC, it is crosslinked. Preferably the crosslinked TSP composition has a Heat Deflection Temperature of about 50° C., more preferably about 100° C., very preferably about 150° C. or more at a load of 0.455 MPa (66 psi) when measured using ASTM Method D648-07.

By a polymeric “composition” is meant that the organic polymer is present together with any other additives usually used with such a type of polymer (see below).

By “coated with a metal” is meant part or all of one or more surfaces of the VTC is coated with a metal.

The metal does not necessarily directly contact a surface of the organic polymer composition. For example an adhesive may be applied to the surface of the organic polymer and the metal coated onto that. Any method of coating the metal may be used (see below).

By “metal” is meant any pure metal or alloy or combination of metals. More than one layer of metal may be present, and the layers may have the same or different compositions.

The VTCs may be any part of the turbocharger (including intercooler) system, including turbocharger housing, intercooler housing, and one or both end tanks (nozzle and/or diffuser for the intercooler). The metal coating is present particularly to reinforce the component being coated, for example by making it stiffer so it will not deform in use, and will be structurally sound. Pressure is generally increased in some parts of the turbocharger system such as the compression section, intercooler and end tanks, and the metal coating may assist in resisting deformation of the VTC(s) due to the pressure increase. The metal coating may also act as a protective or reinforcing element that would resist penetration of broken pieces of the internal turbine, in the event of a failure.

Since the turbocharger is often heated by waste heat from the engine and from heat generated adiabatically in air compression, the organic polymer composition used in the VTC should have a use temperature above the highest temperature expected in operation.

In order to achieve the desired structural property effects with the metal coating, it may be desirable to coat the metal in certain patterns for maximum efficiency. For instance, bands of metal coating may be placed around the turbocharger housing and/or intercooler housing and/or end tanks to prevent their deformation when pressure is generated in the system.

Useful TSPs include epoxy, phenolic, and melamine resins. Parts may be formed from the thermoset resin by conventional methods such as reaction injection molding or compression molding.

Useful TPPs include poly(oxymethylene) and its co-polymers; polyesters such as poly(ethylene terephthalate), poly(1,4-butylene terephthalate), poly(1,4-cyclohexyldimethylene terephthalate), and poly(1,3-poropyleneterephthalate); polyamides such as nylon-6,6, nylon-6, nylon-12, nylon-11, and aromatic-aliphatic co-polyamides; polyolefins such as polyethylene (i.e. all forms such as low density, linear low density, high density, etc.), polypropylene, polystyrene, polystyrene/poly(phenylene oxide) blends, polycarbonates such as poly(bisphenol-A carbonate); fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfides such as poly(p-phenylene sulfide); polyetherketones such as poly(ether-ketones), poly(ether-ether-ketones), and poly(ether-ketone-ketones); poly(etherimides); acrylonitrile-1,3-butadiene-styrene copolymers; thermoplastic (meth)acrylic polymers such as poly(methyl methacrylate); and chlorinated polymers such as poly(vinyl chloride), polyimides, polyamideimides, vinyl chloride copolymer, and poly(vinylidene chloride). “Thermotropic liquid crystalline polymer” (LCP) herein means a polymer that is anisotropic when tested using the TOT test or any reasonable variation thereof, as described in U.S. Pat. No. 4,118,372, which is hereby incorporated by reference. Useful LCPs include polyesters, poly(ester-amides), and poly(ester-imides). One preferred form of LCP is “all aromatic”, that is all of the groups in the polymer main chain are aromatic (except for the linking groups such as ester groups), but side groups which are not aromatic may be present. The TPPs may be formed into parts by the usual methods, such as injection molding, thermoforming, compression molding, extrusion, and the like.

The OP, whether a TSP, TPP or other polymer composition, may contain other ingredients normally found in such compositions such as fillers, reinforcing agents such as glass and carbon fibers, pigments, dyes, stabilizers, toughening agents, nucleating agents, antioxidants, flame retardants, process aids, and adhesion promoters. Another class of materials may be substances that improve the adhesion to the resin of the metal to be coated onto the resin. Some of these may also fit into one or more of the classes named above.

The OP (composition) should preferably not soften significantly at the expected maximum operating temperature of the VTC. Since it is often present at least in part for enhanced structural purposes, it will better maintain its overall physical properties if no softening occurs. Thus preferably the OP has a melting point and/or glass transition temperature and/or a Heat Deflection Temperature at or above the highest use temperature of the OP.

The OP composition (without metal coating) should also preferably have a relatively high flexural modulus, preferably at least about 1 GPa, more preferably at least about 2 GPa, and very preferably at least about 10 GPa. Flexural modulus is measured by ASTM Method D790-03, Procedure A, preferably on molded parts, 3.2 mm thick (⅛ inch), and 12.7 mm (0.5 inch) wide, under a standard laboratory atmosphere. Since these are structural parts, and are usually preferred to be stiff, a higher flexural modulus improves the overall stiffness of the metal coated VTC.

The OP composition may be coated with metal by any known methods for accomplishing that, such as vacuum deposition (including various methods of heating the metal to be deposited), electroless plating, electroplating, chemical vapor deposition, metal sputtering, and electron beam deposition. Preferred methods are electroless plating and electroplating, and a combination of the two. Although the metal may adhere well to the OP composition without any special treatment, usually some method for improving adhesion will be used. This may range from simple abrasion of the OP composition surface to roughen it, addition of adhesion promotion agents, chemical etching, functionalization of the surface by exposure to plasma and/or radiation (for instance laser or UV radiation) or any combination of these. Which methods may be used will depend on the OP composition to be coated and the adhesion desired. Methods for improving the adhesion of coated metals to many OPs are well known in the art. More than one metal or metal alloy may be plated onto the organic resin, for example one metal or alloy may be plated directly onto the organic resin surface because of its good adhesion, and another metal or alloy may be plated on top of that because it has a higher strength and/or stiffness.

Useful metals and alloys to form the metal coating include copper, nickel, iron-nickel, cobalt, cobalt-nickel, and chromium, and combinations of these in different layers. Preferred metals and alloys are copper, nickel, cobalt, cobalt-nickel, and iron-nickel, and nickel is more preferred.

The surface of the organic resin of the structural part may be fully or partly coated with metal. In different areas of the part the thickness and/or the number of metal layers, and/or the composition of the metal layers may vary.

When electroplating it is known that grain size of the metal deposited may be controlled by the electroplating conditions, see for instance U.S. Pat. Nos. 5,352,266 and 5,433,797 and U.S. Patent Publications 20060125282 and 2005020525, all of which are hereby included by reference. In one preferred form at least one of the metal layers deposited has an average grain size in the range of about 5 nm to about 200 nm, more preferably about 10 nm to about 100 nm. In another preferred form of electroplated metal, the metal has an average grain size of at least 500 nm, preferably at least about 1000 nm, and/or an average maximum grain size is about 5000 nm. For all these grain size preferences, it is preferred that that thickest metal layer, if there is more than one layer, be the specified grain size.

The thickness of the metal layer(s) deposited on the organic resin is not critical, being determined mostly by the desire to minimize weight while providing certain minimum physical properties such as modulus, strength and/or stiffness. These overall properties will depend to a certain extent not only on the thickness and type of metal or alloy used, but also on the design of the structural part and the properties of the organic resin composition.

In one preferred embodiment the flexural modulus of the metal coated VTC is at least about twice, more preferably at least about thrice, the flexural modulus of the uncoated OP composition. This is measured in the following way. The procedure used is ISO Method 178, using molded test bars with dimensions 4.0 mm thick and 10.0 mm wide. The testing speed is 2.0 mm/min. The composition from which the VTC is made is molded into the test bars, and then some of the bars are completely coated (optionally except for the ends which do not affect the test results) with the same metal using the same procedure used to coat the VTC. The thickness of the metal coating on the bars is the same as on the VTC. If the thickness on the VTC varies, the test bars will be coated to the greatest metal thickness on the VTC. The flexural moduli of the coated and uncoated bars are then measured, and these values are used to determine the ratio of flexural moduli (flexural modulus of coated/flexural modulus of uncoated). Generally speaking the thicker the metal coating, the greater the flexural modulus ratio between the uncoated and coated OP part.

For use as VTCs, it is also important in many instances that the plated OP be tough, for example be able to withstand impacts. It has surprisingly been found that some of the metal plated OP compositions of the present invention are surprisingly tough. It has previously been reported (M. Corley, et al., Engineering Polyolefins for Metallized Decorative Applications, in Proceedings of TPOs in Automotive 2005, held Jun. 21-23, 2005, Geneva Switzerland, Executive Conference Management, Plymouth, Mich. 48170 USA, p. 1-6) that unfilled or lightly filled polyolefin plaques have a higher impact energy to break than their Cr plated analog. Indeed the impact strength of the plated plaques range from 50 to 86 percent of the impact strength of the unplated plaques. As can be seen from Examples 2-7 below, the impact maximum energies of the plated plaques are much higher than those of the unplated plaques. It is believed this is due to the higher filler levels of the OP compositions used, and in the present parts it is preferred that the OP composition have at least about 25 weight percent, more preferably about 35 weight percent, especially preferably at least about 45 weight percent of filler/reinforcing agent present. A preferred maximum amount of filler/reinforcing agent present is about 65 weight percent. These percentages are based on the total weight of all ingredients present. Typical reinforcing agents/fillers include carbon fiber, glass fiber, aramid fiber, particulate minerals such as clays (various types), mica, silica, calcium carbonate (including limestone), zinc oxide, wollastonite, carbon black, titanium dioxide, alumina, talc, kaolin, microspheres, alumina trihydrate, calcium sulfate, and other minerals.

It is preferred that the ISO179 impact energy (see below for procedure) of the metal plated VTC be 1.2 times or more the impact energy of the unplated OP, more preferably 1.5 times or more. The test is run by making bars of the OP, and plating them by the same method used to make the VTC, with the same thickness of metal applied. If the VTC is metal plated on both sides (of the principal surfaces), the test bars are plated on both sides, while if the VCTC is plated on one side (of the principal surfaces) the test bars are plated on one side. The impact energy of the plated bars are compared to the impact energy of bars of the unplated OP.

Preferably the metal coating will about 0.010 mm to about 1.3 mm thick, more preferably about 0.025 mm to about 1.1 mm thick, very preferably about 0.050 to about 1.0 mm thick, and especially preferably about 0.10 to about 0.7 mm thick. It is to be understood that any minimum thickness mentioned above may be combined with any maximum thickness mentioned above to form a different preferred thickness range. The thickness required to attain a certain flexural modulus is also dependent on the metal chosen for the coating. Generally speaking the higher the tensile modulus of the metal, the less will be needed to achieve a given stiffness (flexural modulus).

Preferably the flexural modulus of the uncoated OP composition is greater than about 200 MPa, more preferably greater than about 500 MPa, and very preferably greater than about 2.0 GPa.

### Example 1

Zytel® 70G25, a nylon 6,6 product containing 25 weight percent chopped glass fiber available from E.I. DuPont de Nemours & Co., Inc. Wilmington, Del. 19898 USA, is injection molded into bars whose central section was 10.0 mm wide and 4.0 mm thick. Before molding the polymer composition is dried at 80° C. in a dehumidified dryer. Molding conditions are melt temperature 280-300° C. and a mold temperature of 80° C. Some of the bars are etched using Addipost® PM847 etch, reported to be a blend of ethylene glycol and hydrochloric acid, and obtained from Rohm & Haas Chemicals Europe. Less than 1 μm of copper is then electrolessly deposited on the surface, followed by 8 μm of electrolytically deposited copper, followed by 100 μm of nickel, on all surfaces. The flexural modulus is then determined, as described above, on the uncoated and metal coated bars. The uncoated bars can have a flexural modulus of 7.7 GPa, and the metal coated bars can have a flexural modulus of 29.9 GPa.

### Examples 2-7

Ingredients to be used, and their designations in the tables are:

Filler 1—A calcined, aminosilane coated, kaolin, Polarite® 102A, available from Imerys Co., Paris, France.

Filler 2—Calmote® UF, a calcium carbonate available from Omya UK, Ltd., Derby DE21 6LY, UK.

Filler 3—Nyad® G, a wollastonite from Nyco Minerals, Willsboro, N.Y. 12996, USA.

Filler 4—M10-52 talc manufactured by Barretts Minerals, Inc., Dillon, Mont., USA.

Filler 5—Translink® 445, a treated kaolin available from BASF Corp., Florham Park, N.J. 07932, USA.

GF 1—Chopped (nominal length 3.2 mm) glass fiber, PPG® 3660, available from PPG Industries, Pittsburgh, Pa. 15272, USA.

GF 2—Chopped (nominal length 3.2 mm) glass fiber, PPG® 3540, available from PPG Industries, Pittsburgh, Pa. 15272, USA.

HS1—A thermal stabilizer containing 78% KI, 11% aluminum distearate, and 11% CuI (by weight).

HS2—A thermal stabilizer contain 7 parts KI, 11 parts aluminum distearate, and 0.5 parts CuI (by weight).

Lube—Licowax® PE 190—a polyethylene wax used as a mold lubricant available from Clariant Corp. Charlotte, N.C. 28205, USA.

Polymer A—Polyamide-6,6, Zytel® 101 available from E.I. DuPont de Nemours & Co., Inc. Wilmington, Del. 19810, USA.

Polymer B—Polyamide-6, Durethan® B29 available from Laxness AG, 51369 Leverkusen, Germany.

Polymer C—An ethylene/propylene copolymer grafted with 3 weight percent maleic anhydride.

Polymer D—A copolyamide which is a copolymer of terephthalic acid, 1,6-diaminohexane, and 2-methyl-1,5-diaminopentane, in which each of the diamines is present in equimolar amounts.

Polymer E—Engage®8180, an ethylene/1-octene co-polymer available by Dow Chemical Co., Midland, Mich., USA.

Wax 1—N,N′-ethylene bisstearamide

Wax 2—Licowax® OP, available from Clariant Corp. Charlotte, N.C. 28205, USA.

The organic polymer compositions to be used in these examples are listed in Table 1. The compositions are made by melt blending of the ingredients in a 30 mm Werner & Pfleiderer 30 mm twin screw extruder.

TABLE 1

| | Ex. | | | | | |
|---|---|---|---|---|---|---|
| | 2 | 3 | 4 | 5 | 6 | 7 |
| Polymer A | | | | | | 58.38 |
| Polymer B | | | 59.61 | | | |
| Polymer C | 2.00 | 0.90 | | 5.00 | 16.90 | 8.44 |
| Polymer D | 55.00 | 35.97 | | 34.32 | 46.95 | |
| Polymer E | 3.00 | 1.10 | | | | |
| Color concentrate | | 1.00 | | | | |
| Filler 1 | | | | 6.00 | 29.25 | 16.25 |
| Filler 2 | | | 25.00 | | | |
| Filler 3 | | 15.00 | | | | |
| Filler 4 | | 0.35 | | | | |
| Filler 5 | 40.00 | | | | | |
| GF 1 | | 45.00 | | 54.00 | 3.25 | 16.25 |
| GF 2 | | | 15.00 | | | |
| HS1 | | 0.43 | | 0.43 | 0.43 | 0.43 |
| HS2 | | | 0.09 | | | |
| Lube | | | | 0.25 | 0.25 | 0.25 |
| Wax 1 | | | 0.30 | | | |
| Wax 2 | | 0.25 | | | | |

The test pieces, which are 7.62×12.70×0.30 cm plaques or ISO 527 test bars, 4 mm thick, gauge width 10 mm, are made by injection molding under the conditions given in Table 2. Before molding the polymer compositions are dried for 6-8 hr in dehumidified air under the temperatures indicated, and can have a moisture content of <0.1% before molding.

TABLE 2

| Ex. | Drying Temp., ° C. | Melt Temp., ° C. | Mold Temp., ° C. |
|---|---|---|---|
| 2 | 100 | 320-330 | 140-160 |
| 3 | 100 | 320-330 | 140-160 |
| 4 | 80 | 210-230 | 80 |
| 5 | 100 | 320-330 | 140-160 |
| 6 | 100 | 320-330 | 140-160 |
| 7 | 100 | 320-330 | 140-160 |

These test specimens are then etched in sulfochromic acid or Rohm & Haas Chrome free etching solution, and rendered conductive on all surface by electroless deposition of a very thin layer of Ni. Subsequent galvanic deposition of 8 μm of Cu wis followed by deposition of a 100 μm thick layer of fine grain N—Fe (55-45 weight) using a pulsed electric current, as described in U.S. Pat. No. 5,352,266 for making fine grain size metal coatings.

The samples are tested by one or both of the following methods:

ISO 6603-2—Machine Instron® Dynatup Model 8250, Support Ring 40 mm dia, Hemispherical Tup 20 mm dia, Velocity 2.2 m/s, Impacter weight 44.45 kg, Temperature 23° C., Condition dry as made. Tests are run on the plaques described above.

ISO 179-1eU—Sample Unnotched, Pendulum energy 25 J, Impact velocity 3.7 m/s, Temperature 23° C., Condition dry as made. Tests are run on the gauge part of the ISO 527 test bars described above.

Testing results are given in Table 3.

TABLE 3

| | ISO 6603-2 | | | | | |
|---|---|---|---|---|---|---|
| | Maximum | | Maximum | | ISO 179 | |
| | Energy, J | | Load, kN | | kJ/m² | |
| | | Ni—Fe | | Ni—Fe | | Ni—Fe |
| Ex. | Unplated | Plated | Unplated | Plated | Unplated | Plated |
| 2 | | | | | 90.4 | 109 |
| 3 | 2.5 | 6.8 | 1.0 | 2.7 | 50.2 | 100 |
| 4 | 2.3 | 16.2 | 0.9 | 5.0 | 60.3 | 129 |
| 5 | 10.0 | 15.0 | 2.6 | 4.0 | 53.6 | 108 |
| 6 | 8.5 | 23.3 | 1.8 | 4.7 | 40.7 | 87 |
| 7 | 7.8 | 24.3 | 2.3 | 6.8 | | |

1. A vehicular turbocharger component, comprising an organic polymer composition which is coated at least in part by a metal.

2. The vehicular turbocharger component as recited in claim 1 wherein said organic polymer is one of a thermoplastic and thermoset, if a thermoplastic has a melting point and/or a glass transition point of 100° C. or more, or if a thermoset has a heat deflection temperature of 100° C. or more at a load of 0.455 MPa.

3. The vehicular turbocharger component as recited in claim 1 wherein said vehicular turbocharger component is metal coated on one or more sides of said vehicular turbocharger component.

4. The vehicular turbocharger component as recited in claim 1 wherein at least one layer of said metal coating has an average grain size of 5 nm to 200 nm.

5. The vehicular turbocharger component as recited in claim 1 wherein a thickest layer of said metal coating has an average grain size of at least 500 nm to 5,000 nm.

6. The vehicular turbocharger component as recited in claim 5 wherein said metal coating is 0.010 mm to 1.3 mm thick.

7. The vehicular turbocharger component as recited in claim 5 wherein said metal coating is 0.025 mm to 1.3 mm thick.

8. The vehicular turbocharger component as recited in claim 1 wherein said turbocharger component is at least one of a turbocharger housing, intercooler housing, and an end tank.

9. (canceled)

10. The vehicular turbocharger component of claim 1, wherein an impact energy of a metal coated section of the organic polymer composition is at least 1.5 times an impact energy of an uncoated section of the organic polymer composition.

11. The vehicular turbocharger component of claim 1, wherein a flexural modulus of a metal coated section of the organic polymer composition is at least 2 times a flexural modulus of an uncoated section of the organic polymer composition.

12. The vehicular turbocharger component of claim 11, wherein the flexural modulus of the metal coated section of the organic polymer composition is at least 3 times the flexural modulus of the uncoated section of the organic polymer composition.

13. The vehicular turbocharger component of claim 11, wherein the flexural modulus of the uncoated section of the organic polymer composition is greater than 200 MPa.

14. The vehicular turbocharger component of claim 11, wherein the flexural modulus of the uncoated section of the organic polymer composition is greater than 500 MPa.

15. The vehicular turbocharger component of claim 11, wherein the flexural modulus of the uncoated section of the organic polymer composition is greater than 2.0 GPa.

16. The vehicular turbocharger component of claim 1, wherein the organic polymer composition includes a filler/reinforcing agent, the filler/reinforcing agent being at least 25% weight of the organic polymer composition.

17. The vehicular turbocharger component of claim 16, wherein the filler/reinforcing agent is at least 35% weight of the organic polymer composition.

18. The vehicular turbocharger component of claim 16, wherein the filler/reinforcing agent is at least 45% weight of the organic polymer composition.

19. The vehicular turbocharger component of claim 1, comprising a polyamide optionally containing one or more additives selected from the group consisting of fillers, reinforcing agents, pigments, dyes, stabilizers, toughening agents, nucleation agents, antioxidants, flame retardants, process aids, and adhesion promoters.

20. The vehicular turbocharger component of claim 1, comprising a metallic material comprising at least one element selected from the group consisting of copper, cobalt, iron and nickel.
